(19) United States
(12) Patent Application Publication
(10) Pub. No.: US 2017/0330206 A1
(43) Pub. Date: Nov. 16, 2017

(54) MOTION LINE PROCESSING SYSTEM AND MOTION LINE PROCESSING METHOD

(71) Applicant: HITACHI SOLUTIONS, LTD., Shinagawa-ku, Tokyo (JP)

(72) Inventors: Tomoki YADA, Tokyo (JP); Naoya OOE, Tokyo (JP); Keiji HIDAKA, Tokyo (JP)

(21) Appl. No.: 15/524,530

(22) PCT Filed: Jan. 7, 2016
(86) PCT No.: PCT/JP2016/050327

§ 371 Date: May 4, 2017

(30) Foreign Application Priority Data
Mar. 20, 2015 (JP) 2015-057732

(51) Int. Cl. G06Q 30/02

(52) U.S. Cl. CPC G06Q 30/0201

(57) ABSTRACT

It is provided a motion line processing system, which can access motion line information including a history of movement of a person, event definition information including a condition for determining an occurrence of an event in a predetermined region, and transaction information including information of transaction of a product, comprising: an event information creation unit configured to analyze the motion line information with reference to the event definition information, and create event information including a start time of the event, an end time of the event, and identification information of a person who has caused the event; and an association processing unit configured to compare the event information with a transaction date/time, and associate the motion line information with the transaction information in a case where the transaction date/time is included between the start time and the end time, and the event is a transaction event at a transaction location.

### CLAIM OF PRIORITY

The present application claims priority from Japanese patent application JP 2015-57732 filed on Mar. 20, 2015, the content of which is hereby incorporated by reference into this application.

### BACKGROUND OF THE INVENTION

The present invention relates to a motion line processing system that analyzes motion line information.

In recent years, with reduced prices for various sensors and the evolution of networks, cameras and position measurement devices have been installed inside shops, and analysis has been conducted on information of customers walking within the shops in order to increase sales as well as reduce costs for the shops.

Conventionally, a method is known in which movements of persons are tracked using laser light radiated from measurement sensors installed inside the shop. In this manner, it is possible to attain the movement (motion line) of persons on which the laser light has been radiated. Meanwhile, shops store in a database transaction information of customers at cashiers and the like. By associating the aforementioned motion line information with the transaction information, it is possible to attain information on the movements of the customer within the shop and what products the customer purchased. It is possible on the basis of this information to improve sales and the like by reconfiguring the layout of the shop.

Patent literature 1 (JP 2009-258782 A) is an example of background art of the present technique. Patent literature 1 discloses a method by which the motion lines attained by video captured by cameras are visually associated with transaction information by an operator who is viewing the video.
Patent literature 1: JP 2009-258782 A
Non-Patent literature 1: Tracking Pedestrians Using Multiple Single-Row Laser Range Scanners and Its Reliability Evaluation, Katsuyuki NAKAMURA et al., Institute of Electronics, Information and Communication Engineers D-II VOL. J88-D-II, pp. 1143-1152, Jul. 1, 2005

### SUMMARY OF THE INVENTION

However, the technique disclosed in Patent literature 1 requires an operator to visually determine the associations. In a shop with more than one thousand customers per day, for example, determining such associations would require a large amount of time and incur high personnel costs, which has meant that performing association was difficult.

The present invention takes into account this situation, and an object thereof is to provide a method and a device by which a large amount of motion line and transaction information are automatically associated.

The representative one of inventions disclosed in this application is outlined as follows. There is provided a motion line processing system, which is formed by a computer including a processor and memory, the motion line processing system being configured to access motion line information including a history of movement of a person measured by a position measurement device, event definition information including a condition for determining an occurrence of an event in a predetermined region, and transaction information including information of transaction of a product, the motion line processing system comprising: an event information creation unit configured to analyze the motion line information with reference to the event definition information, and create event information including a start time of the event, an end time of the event, and identification information of a person who has caused the event; and an association processing unit configured to compare the event information with a transaction date and time included in the transaction information, and associate the motion line information with the transaction information in a case where the transaction date and time is included between the start time and the end time and the event is a transaction event at a transaction location.

According to representative aspects of the present invention, it is possible to automatically and appropriately associate motion line information with transaction information. Problems, configurations, and effects other than those described above are made clear from the following description of an embodiment of this invention.

### BRIEF DESCRIPTION OF THE DRAWINGS

FIG. 1 is a diagram illustrating a configuration of a motion line information management system according to an embodiment of the present invention.

FIG. 2 is a diagram illustrating an example of an arrangement in a shop where a motion line information management system is installed according to the present embodiment.

FIG. 3 is a block diagram illustrating a physical configuration of a motion line information management server according to the present embodiment.

FIG. 4 is a diagram illustrating a configuration example of motion line information according to the present embodiment.

FIG. 5 is a diagram illustrating a configuration example of transaction information according to the present embodiment.

FIG. 6 is a diagram illustrating a configuration example of event definition information according to the present embodiment.

FIG. 7 is a diagram illustrating a configuration example of event information according to the present embodiment.

FIG. 8 is a diagram illustrating a configuration example of shelving arrangement information according to the present embodiment.

FIG. 9 is a diagram illustrating sections in the shop where motion lines of customers are acquired according to the present embodiment.

FIG. 10 is a diagram illustrating a movement state of a customer inside the shop according to the present embodiment.

FIG. 11 is a flowchart for an event information creation process according to the present embodiment.

FIG. 12 is a flowchart for a motion line/transaction association information creation process according to the present embodiment.

FIG. 13 is a flowchart for a customer ID selection process according to the present embodiment.

FIG. 14 is a diagram illustrating a configuration example of motion line/transaction association information according to the present embodiment.

### DETAILED DESCRIPTION OF THE PREFERRED EMBODIMENTS

An embodiment of the present invention will be described below with reference to figures. The present invention is not limited to the embodiment below, and various modifications can be made within technical idea. Also, in all of the drawings for describing the embodiment, members having the same function are assigned the same or related reference characters, and redundant explanations thereof are omitted.

<System Configuration>

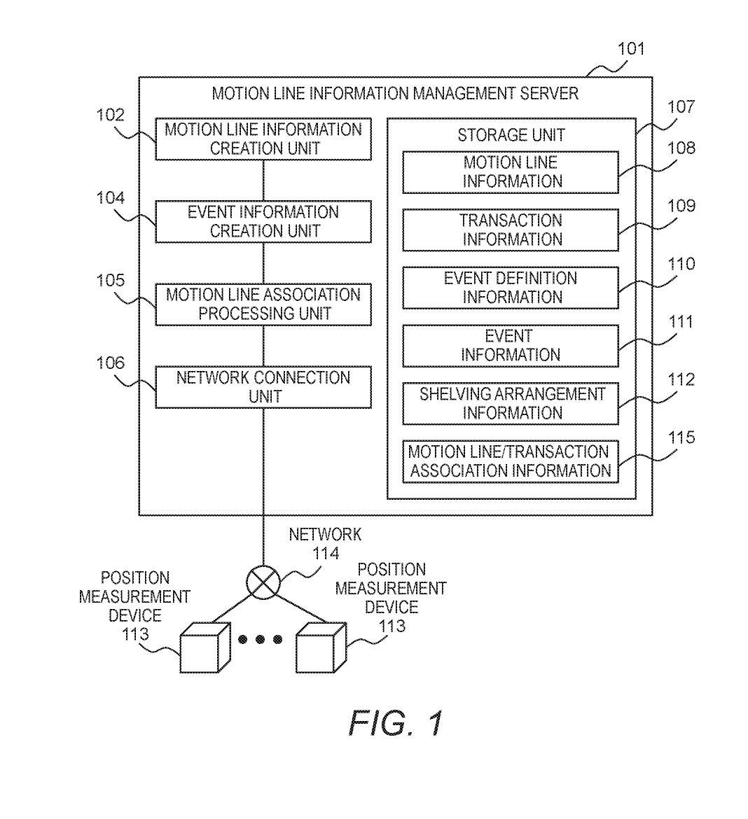

FIG. 1 is a diagram illustrating a configuration of a motion line information management system of an embodiment according to the invention.

A motion line processing system of the present embodiment has position measurement devices 113 installed in a shop 201 and a motion line information management server 101.

The motion line processing system of the present embodiment associates the path of movement of a customer acquired as motion line information with transaction information of the customer at a cashier or the like at a shop, a shopping mall, or the like, and generates motion line information useful for analyzing various types of information.

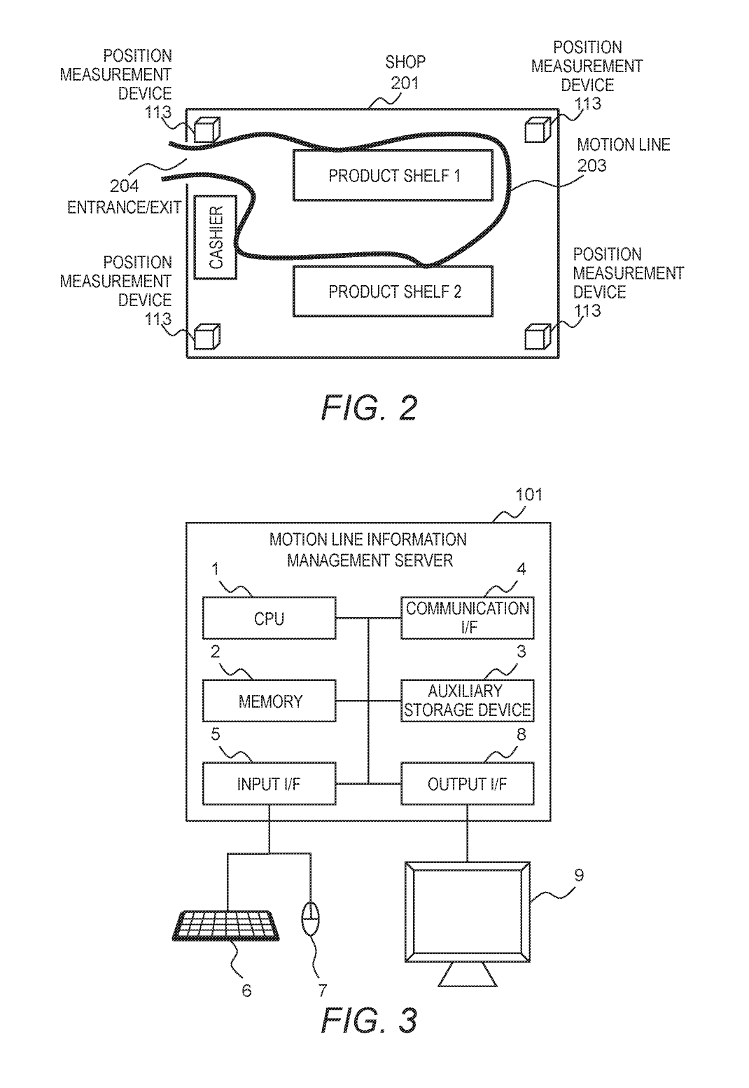

The position measurement devices 113 record information on the path of movement (motion line) of a customer inside the shop. Examples of the position measurement devices 113 include a position measurement device, such as three dimensional sensors, an indoor GPS (Global Positioning System), and a strength of radio waves from WiFi access points or weak radio wave wireless systems (Bluetooth, etc.). However, the position measurement devices are not limited to the above examples, and position measurement devices that rely on other methods may be used. Three dimensional sensors used as the position measurement devices 113 can obtain the motion lines of persons inside the shop by measuring the distance from objects inside the shop at a given time, and analyzing and extracting objects that are persons, for example. An example of a motion line 203 generated when a person moves inside a shop is illustrated in FIG. 2. FIG. 2 illustrates an example with four position measurement devices 113, but any number of position measurement devices 113 may be used.

The network 114 connects the position measurement devices 113 with the motion line information management server 101, and enables communication between these devices. The network 114 can be Ethernet- or WiFi-based. Alternatively, the position measurement devices 113 and the motion line information management server 101 may be connected via a data communication interface such as USB (universal serial bus). As long as the position measurement devices 113 and the motion line information management server 101 can communicate with each other, other protocols besides those mentioned above may be used.

Additionally, the position measurement devices 113 and the motion line information management server 101 may be not connected to each other. In such a case, data acquired by the position measurement devices 113 may be stored manually in the motion line information management server 101, for example.

<Configuration of Motion Line Information Management Server>

Next, with reference to FIG. 1, the logical configuration of the motion line information management server 101 will be described.

The motion line information management server 101 has a motion line information creation unit 102, an event information creation unit 104, a motion line association processing unit 105, storage unit 107, and a network connection unit 106.

The motion line information creation unit 102 creates motion line information 108 by acquiring measurement information from the position measurement devices 113. The event information creation unit 104 creates event information 111 indicating events generated in each motion line included in the motion line information 108 on the basis of event definition information 110 such as a person stopping in front of a product shelf or a transaction at a cashier. The motion line association processing unit 105 searches for a motion line corresponding to the transaction information 109 using the transaction date/time included in the transaction information 109, the time at which a transaction event occurred at the cashier, and shelving arrangement information 112 indicating product shelves where products are placed, and then the motion line association processing unit 105 associates the transaction information with the motion line and creates motion line/transaction association information 115.

The storage unit 107 stores the motion line information 108, the transaction information 109, the event definition information 110, the event information 111, the shelving arrangement information 112, the motion line/transaction association information 115, and the like.

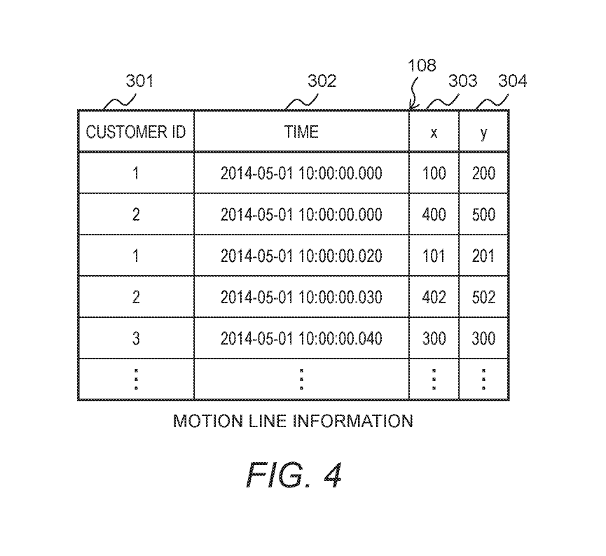

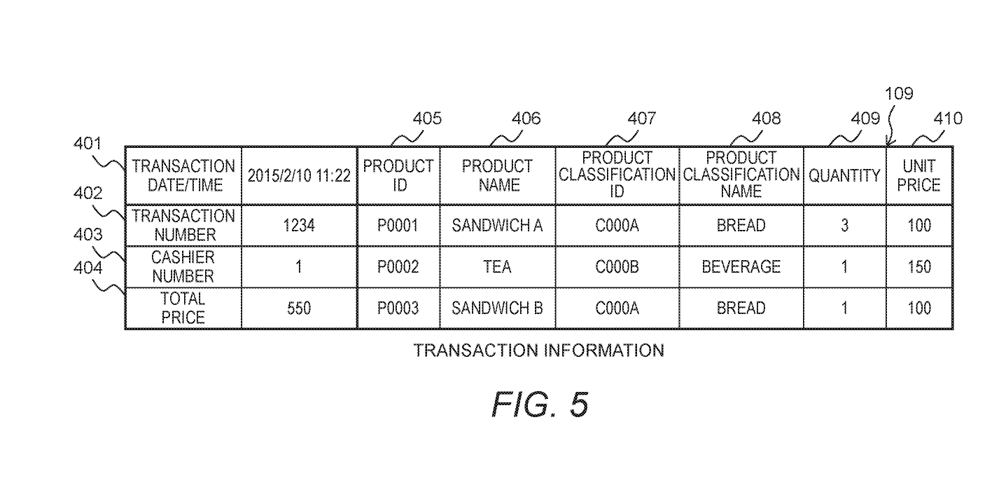

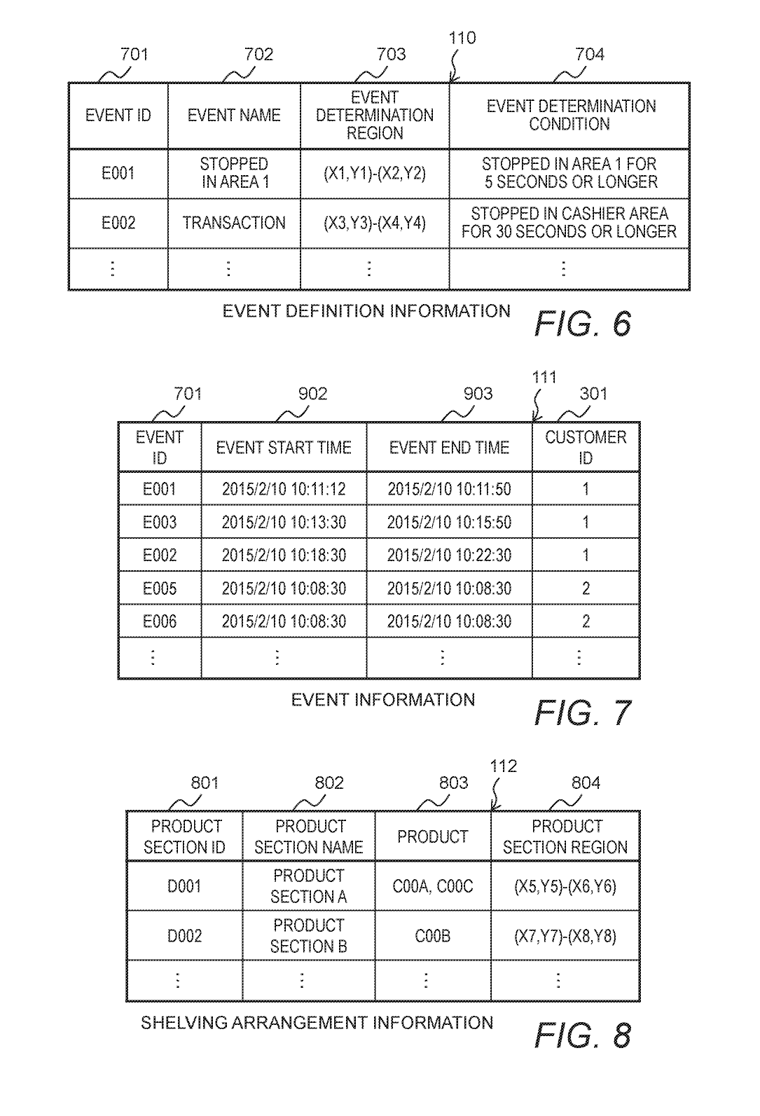

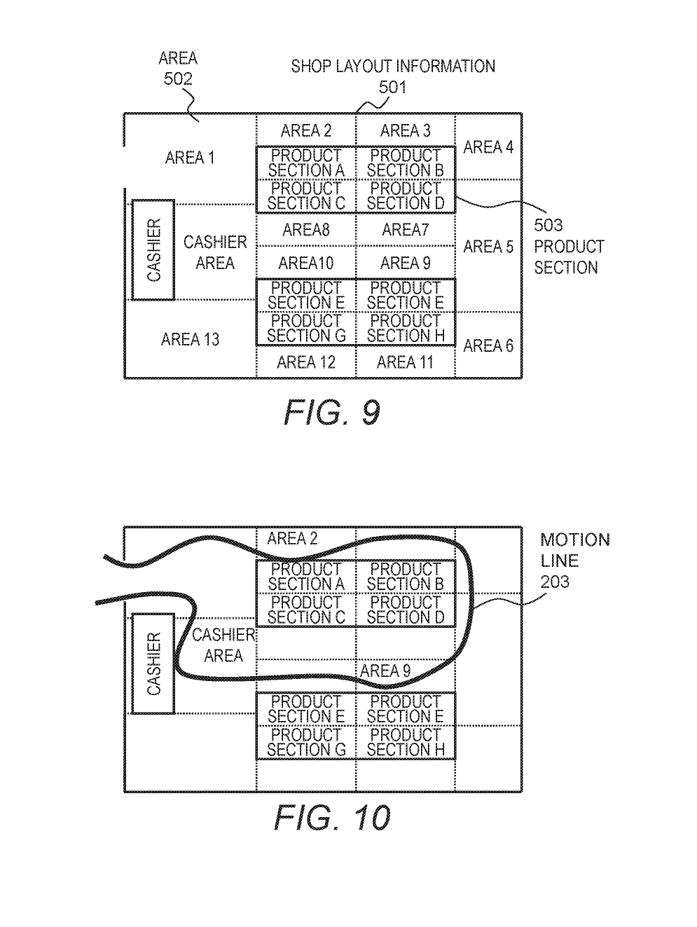

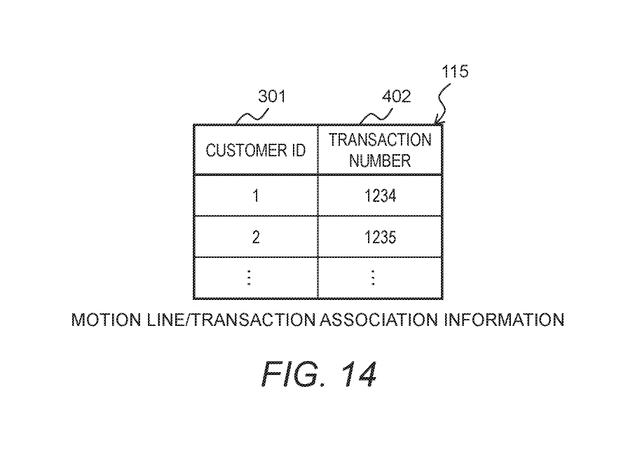

The motion line information 108 stores the position of the customer inside the shop in association with time. Details of the motion line information 108 will be described later with reference to FIG. 4. The transaction information 109 stores transaction content created when a customer purchases a product at the cashier or the like. Details of the transaction information 109 will be described later with reference to FIG. 5. The event definition information 110 is information that defines events. Details of the event definition information 110 will be described later with reference to FIG. 6. The event information 111 stores results of determining the motion line. Details of the event information 111 will be described later with reference to FIG. 7. The shelving arrangement information 112 is information in which the position of a product section 503 within the shop (see FIG. 9) is associated with a product classification ID 407 of products arranged in each product section. Details of the shelving arrangement information 112 will be described later with reference to FIG. 8. The motion line/transaction association information 115 is information in which the motion line is associated with the transaction, and will be used in Example 2 below. Details of the motion line/transaction association information 115 will be described later with reference to FIG. 14.

FIG. 3 is a block diagram illustrating a physical configuration of the motion line information management server 101.

The motion line information management server 101 of the present embodiment is constituted of a computer having a processor 1 (CPU), a memory 2, an auxiliary storage device 3, and a communication interface 4.

The processor 1 executes programs stored in the memory 2. The memory 2 includes ROM, which is a non-volatile memory element, and RAM, which is a volatile memory element. The ROM includes fixed programs (such as the BIOS). The RAM is a high speed and volatile memory element such as DRAM (dynamic random access memory), and temporarily stores programs to be executed by the processor 1 and data used during execution of the programs.

The auxiliary storage device 3 constitutes the storage unit 107 and is a large capacity non-volatile storage device such as a magnetic storage device (HDD) or flash memory (SSD), and stores programs to be executed by the processor 1 and data to be used while executing the programs. In other words, the programs are read from the auxiliary storage device 3, loaded into the memory 2, and executed by the processor 1.

The communication interface 4 constitutes the network connection unit 106, and is a network interface device that controls communication with other devices (position measurement devices 113, etc.) according to a predetermined protocol.

The motion line information management server 101 may have an input interface 5 and an output interface 8. The input interface 5 is connected to a keyboard 6, a mouse 7, or the like and receives input from an operator. The output interface 8 is connected to a display device 9, a printer, or the like and outputs execution results of the program in a format readable by an operator.

Programs executed by the processor 1 are provided to the motion line information management server 101 through removable media (such as CD-ROMs and flash memory) or through a network, and are stored in the non-volatile auxiliary storage device 3, which is a non-transitory storage medium. Thus, the motion line information management server 101 would have an interface for reading in data from removable media.

The motion line information management server 101 is a computer system constituted of one physical computer or a plurality of logical or physical computers, and may be operated in individual threads on the same computer, or in virtual computers created in a plurality of physical computer resources. That is, the motion line information management server 101 may be installed in the shop or provided in the cloud. Also, the respective functions of the motion line information management server 101 may be provided on different computers.

<Configuration Example of Motion Line Information>

FIG. 4 is a diagram illustrating a configuration example of the motion line information 108.

The motion line information 108 illustrated in FIG. 4 can be attained using the technique disclosed in Non-Patent literature 1, for example. In the example illustrated in FIG. 4, the motion line information 108 stores in chronological order, for example, a customer ID 301 for uniquely identifying a customer, a time 302 at which the position of the customer was measured, and the two-dimensional position (x coordinate 303, y coordinate 304) of the customer within the shop.

The data in the first row of FIG. 4 will be described in detail as an example of the motion line information 108. The motion line information creation unit 102 detects the position of the customer inside the shop by analyzing information measured by the position measurement devices 113. A unique identifier of “1” is assigned as the customer ID 301 for the detected customer, the detected time (May 1, 2014, 10:00:00.000) is stored as the time 302, and the horizontal component (100) of the position of the customer in the shop is stored as the x coordinate 303 with the vertical component (200) being stored as the y coordinate 304. Here, the coordinate origin and unit to be used for the coordinate values may be defined arbitrarily.

The motion line information creation unit 102 stores the position of the customer inside the store as the motion line information 108 at an arbitrary timing or periodically (for example, at a predetermined time interval). However, regarding the customer ID 301, in a case where it is determined that the detected customer is the same person as a previously detected customer, the same identifier is used.

Thus, if data for the same customer ID 301 is selected from the motion line information 108 illustrated in FIG. 4, then a series of information pertaining to when and where inside the shop the customer was present, or in other words, the motion line information can be attained.

Although not illustrated in FIG. 4, the motion line information 108 may include attributes of the customer (such as gender and age). Attributes of the customer such as gender and age can be attained by analyzing a facial image captured at the entrance of the shop.

<Configuration Example of Transaction Information>

FIG. 5 is a diagram illustrating a configuration example of the transaction information 109.

The transaction information 109 stores transaction content created when a customer purchases a product at the cashier or the like. The transaction information 109 includes, in each record, a transaction date/time 401, a transaction number 402, a cashier number 403, and a total price 404. Also, each record includes data for one or more purchased products, that is, a product ID 405, a product name 406, a product classification ID 407, a product classification name 408, a quantity 409, and a unit price 410.

The transaction date/time 401 records the date and time when the transaction is performed at a cashier or the like. In the illustrated example, the date and time are Feb. 10, 2015, 11:22, and thus, the time is represented in minute unit. This is because some cash registers only record the transaction date/time to the minute, and thus, the transaction information should have the time recorded according to the time unit recorded at the cashier. The recorded time unit may be in second increments or less instead of minute increments.

The transaction number 402 is a number used to distinguish between a plurality of transactions, and is “1234” in the illustrated example. The transaction number 402 may start at “1” and be incremented by 1 for each transaction, for example, but the transaction number 402 may be decided by another rule.

The cashier number 403 is an identifier for identifying the cashier. In the illustrated example, the cashier number is “1”.

The total price 404 is the total price for purchased products.

The product ID 405 is an identifier for identifying the purchased product. In the illustrated example, “P0001”, “P0002”, and “P0003” are recorded for the respective purchased products.

The product name 406 is a name of the purchased product. In the illustrated example, the product names are “sandwich A”, “tea”, and “sandwich B”.

The product classification ID 407 is an identifier for classifying products according to characteristics thereof. In the illustrated example, “sandwich A” and “sandwich B” can be classified as “bread”, and thus, both products are assigned the same product classification ID 407 of “C000A”.

The product classification name 408 is a name of the product classification. In the illustrated example, the product classification names are “bread” and “beverage”.

The quantity 409 is a number of each product purchased. The unit price 410 is a price per product item.

Although not illustrated in FIG. 5, the transaction information 109 may include membership numbers. When a customer presents a membership card (such as a rewards card) at the cashier, attributes of the customer (such as gender, age, and place of residence) can be known, for example.

<Configuration Example of Event Definition Information>

FIG. 6 is a diagram illustrating a configuration example of the event definition information 110.

The event definition information 110 is information to define events, and includes an event ID 701, an event name 702, an event determination region 703, and an event determination condition 704. An event is an action by a customer in the shop such as the customer stopping in an area 502 in the aisle in front of the product section 503, or a transaction (check out) at the cashier.

The event ID 701 is an identifier for identifying the event. The event name 702 is a name of the event. The event determination region 703 is a region for determining the occurrence of an event. The event determination condition 704 is a condition for determining whether an event has occurred on a motion line present in the event determination region 703.

The data in the first row of FIG. 6 will be described in detail as an example. The event ID is “E001” and is an event indicating that a customer has stopped inside an area 1 (see FIG. 9). The event determination region 703 is a rectangular region (X1, Y1)-(X2, Y2) indicating the “area 1”. The event determination region 703 may be a shape other than rectangular. The event determination condition 704 for determining whether a customer has stopped in a certain area is defined as “stopping for five seconds or longer in the area 1”.

Besides what was illustrated, the event definition information 110 may include a condition whereby it is determined that the customer has stopped in the area if he/she is moving at the minimum speed. Also, sensors provided in product shelves may also use the acquired information and generate an event in a case where the customer is facing a shelf.

<Configuration Example of Event Information>

FIG. 7 is a diagram illustrating a configuration example of the event information 111.

The event information 111 is information of results of determining the motion line using the event definition information 110, and includes the event ID 701, an event start time 902, an event end time 903, and the customer ID 301.

The event ID 701 is an identifier for identifying the event. The event start time 902 is a time when an event has started, and the event end time 903 is a time when the event has ended. The customer ID 301 is an identifier that distinguishes motion lines.

<Configuration Example of Shelving Arrangement Information>

FIG. 8 is a diagram illustrating a configuration example of the shelving arrangement information 112.

The shelving arrangement information 112 is information in which the position of a product section 503 within the shop (see FIG. 9) is associated with a product classification ID 407 of products arranged in each product section, and includes a product section ID 801, a product section name 802, a product 803, and a product section region 804.

The product section ID 801 is an identifier for identifying the product section 503. The product section name 802 is a name of the product section. The product 803 is the product classification ID 407 of the product arranged in the product section, and may include a plurality of product classification IDs 407. The product section region 804 indicates the product section 503 in the shop. The product section region 804 may be a shape other than rectangular.

<Configuration Example of Shop Layout Information>

FIG. 9 is a diagram illustrating sections in the shop where motion lines of customers are acquired.

Regions that divide up the product shelves according to the classification of the arranged products are the product sections 503. One method to allocate the product sections 503 is a method of allocating shelves where products with the same product classification IDs 407 are arranged in the same product sections 503, but other methods may be used. In the illustrated example, the product shelves are classified into eight product sections 503: “product section A” to “product section H”. There is no limit on the number of product sections 503 as long as there are a plurality thereof.

Similarly, paths inside the shop are divided into a plurality of areas 502. In the illustrated example, there are 14 areas 502 including “area 1” to “area 13” and “cashier area”. There is no limit on the number of areas 502 as long as there are a plurality thereof. By setting “area 2” as the path in front of the “product section A, for example, it can be determined that a person who has stopped in “area 2” is interested in products arranged in the “product section A” and might purchase such products. Also, by providing a “cashier area” in front of the cashier, it can be determined that there is a possibility that a customer who is in the “cashier area” for a certain period of time or longer has made a transaction at the cashier.

FIG. 10 is a diagram illustrating the movement state of the customer inside the shop.

The motion line 203 indicates that the customer stopped in “area 2” and picked a product in the “product section A”, stopped in “area 9” and picked a product in the “product section F”, and then made a transaction in the “cashier area”.

### Example 1

Below, Example 1 of the present invention will be described.

<Event Information Creation Method>

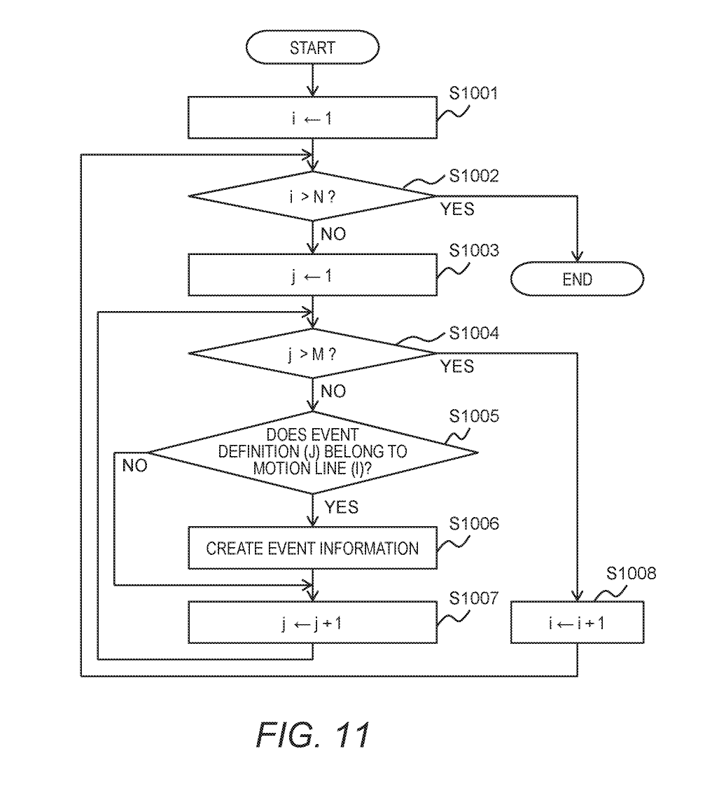

FIG. 11 is a flowchart for the process in which the event information creation unit 104 creates the event information 111 using the event definition information 110.

In the description of the event information creation process, the motion line information 108 includes 1-N customer IDs 301. A motion line for a customer ID 301 of i (1≦i≦N) is expressed as motion line (i). Also, there are 1-M pieces of event definition information 110 defined, and the jth (1≦j≦M) piece of event definition information 110 is expressed as event definition (j).

First, the variable i is initialized to 1 (S1001). Next, it is determined whether the variable i is greater than N (S1002). In a case where the variable i is greater than N (S1002 returns “YES”), this signifies that the process has been completed for all motion lines, and thus, the event information creation process is ended. On the other hand, in a case where the variable i is less than or equal to N (S1002 returns “NO”), there are some unprocessed motion lines, and thus, the variable j is initialized to 1 (S1003).

Then, it is determined whether the variable j is greater than M (S1004). In a case where the variable j is greater than M (S1004 returns “YES”), the variable i is incremented by 1 (S1008), the process returns to step S1002, and the next motion line is processed. On the other hand, in a case where the variable j is less than or equal to M (S1004 returns “NO”), it is determined whether the motion line (i) for the customer ID of i belongs to the event definition (j) of the event definition information 110 (S1005). The first row of the event definition information 110 will be described in detail. It is determined whether there are portions of the motion line (i) that satisfy the event determination condition 704 within the event determination region 703, in other words, whether there are portions of the motion line where the customer has stopped for 5 seconds or longer within the area 1 defined by the region (X1, Y1)-(X2, Y2).

In a case where the result is that the event definition (j) is not satisfied (S1005 returns “NO”), the variable j is incremented by 1 (S1007), the process returns to step S1004, and the next event definition is processed. On the other hand, in a case where the event definition (j) is satisfied (S1005 returns “YES”), an event definition 111 is created (S1006).

Specifically, in a case where the motion line (i) satisfies the event definition (j), the time at which the motion line (i) entered the event determination region 703 is recorded as the event start time 902 and the time at which the motion line (i) left the event determination region 703 is recorded as the event end time 903, the event ID 701 and the customer ID 301 are recorded, and the event definition 111 is created.

After creating the event definition 111, the variable j is incremented by 1 (S1007), the process returns to step S1004, and the next event definition is processed.

<Association Method for Motion Line Information and Transaction Information>

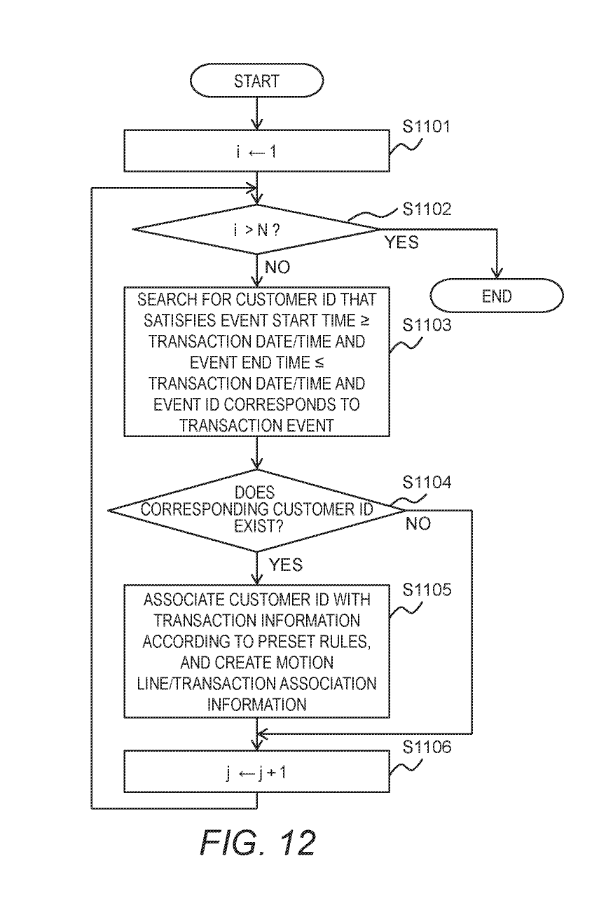

FIG. 12 is a flowchart for the process in which the motion line association processing unit 105 creates the motion line/transaction association information 115 using the event information 111 and the transaction information 109.

In the description of the motion line/transaction association information creation process, there are 1-N pieces of transaction information 109, and the ith (1≦i≦N) piece of transaction information 109 is expressed as the transaction information (i).

First, the variable i is initialized to 1 (S1101). Next, it is determined whether the variable i is greater than N (S1102). In a case where the variable i is greater than N (S1002 returns “YES”), this signifies that the process has been completed for all pieces of transaction information, and thus, the motion line/transaction association information creation process is ended. On the other hand, in a case where the variable i is less than or equal to N (S1002 returns “NO”), this signifies that there is unprocessed transaction information, and thus, the transaction information (i) is compared with the event information 111, and a customer ID 301 that satisfies predetermined conditions is searched (S1103).

Specifically, in step S1103, a customer ID 301 is searched that satisfies the following conditions: (event start time date/time of transaction information (i)) and (event end time date/time of transaction information (i)) and (event ID is an identifier corresponding to transaction event). A transaction event is an event that has occurred in the cashier area among the events recorded in the event information 111 (event with ID of E0002 in FIGS. 6 and 7).

Then, it is determined whether the corresponding customer ID 301 has been found in step S1103 (S1104). As a result, in a case where the corresponding customer ID 301 has not been found (S1104 returns “NO”), step S1105 is not executed, the variable j is incremented by 1 in step S1106, the process returns to step S1102, and then the next piece of transaction information is processed.

On the other hand, in a case where one or more customer IDs 301 have been found (S1104 returns “YES”), the customer ID 301 is associated with the transaction information (S1105). Specifically, in a case where a plurality of customer IDs 301 have been found in step S1103, one customer ID is selected according to a predetermined rule. For example, among the plurality of pieces of transaction information selected as candidates to associate with one customer ID, the transaction information with the earliest transaction event start time may be selected. The selected transaction information is associated with the customer ID 301, and the motion line/transaction association information 115 illustrated in FIG. 14 is created.

FIG. 14 is a diagram illustrating a configuration example of the motion line/transaction association information 115.

The motion line/transaction association information 115 is information in which the customer ID is associated with the transaction information, and includes the customer ID 301 and the transaction number 402. The customer ID 301 is an identifier for uniquely identifying the customer. The transaction number 402 is a number used to distinguish between a plurality of transactions.

By associating the customer ID 301 included in the motion line information 108 with the transaction number 402 of the transaction information 109 depending on the motion line/transaction association information 115, it is possible to know the relationship between the motion line information 108 and the transaction information 109.

In the present example, in order to simplify the explanation, an example was described in which only one cash register was provided, but a plurality of cash registers may be provided. In a case where a plurality of cash registers are provided, a transaction event would be defined for each cash register, and whether or not the transaction event matches the cashier number 403 in the transaction information 109 would be added to the determination conditions of step S1103.

Also, in a case where the time in the cash register is not synchronized with the transaction information 109 time, and the time is offset between cash registers or between the transaction information 109 and the cash register, time synchronization by NTP, manual operation, or some other method would be performed, for example. The time may be corrected by an appropriate method.

As described above, Example 1 of the present invention has: the event information creation unit 104, which analyzes the motion line information 108 with reference to the event definition information 110 and creates the event information 111 including the event start time 902, the event end time 903, and the customer ID 301 of the person who caused the event; and the motion line association processing unit 105, which compares the event information 111 with the transaction date/time 401 included in the transaction information 109, and generates the motion line association information 115 for associating the motion line information 108 with the transaction information 109 in a case where, upon comparing the event information 111 with the transaction date/time 401, the transaction date/time 401 is included between the start time 902 and the end time 903 and the event is a transaction event in the cashier area. Thus, it is possible to appropriately associate the motion line information with the transaction information automatically. In this manner, it is possible to see a series of purchasing actions such as the path traveled within the shop, the product shelves that the customer approached, the products purchased, and the like, using the motion line of the customer who entered the shop and purchased the products, for example.

Also, the motion line association processing unit 105 associates the transaction information with the event with the earliest start time 902 among the events having transaction dates/times 401 between the start time 902 and the end time 903, and thus, even if a plurality of pieces of transaction information are included in the time at which the event has occurred, it is possible to appropriately associate the motion line information with the transaction information.

Furthermore, by using the motion line information associated with the transaction information in the present example, the following business value is created: (1) elimination of disposal costs by optimizing orders; (2) improving sales by leading customers to locations in the shop that are not frequently visited by customers; (3) improving sales by removing and replacing products that are no longer popular; (4) reducing opportunity cost by avoiding out-of-stock events; and (5) improving sales by optimizing customer traffic within the shop.

### Example 2

Below, Example 2 of the present invention will be described. In Example 1, there are cases in which the customer ID 301 is not correctly associated transaction information 109 such as when a transaction event is not correctly generated for a customer that has made a transaction. In order to solve this problem, in Example 2, the customer ID 301 is associated with the transaction information 109 using information concerning whether the customer has stopped by a path in front of a product section where products belonging to the product classification ID 407, included in the transaction information 109, are arranged.

For example, in a case where a plurality of persons enter the shop, each person takes a product, and in the end one person makes the transaction, the person making the transaction has not gone to all paths in front of the product sections where the products belonging to the product classification IDs 407 are arranged. Also, in a case where among the products purchased by the person making the transaction, there is a high proportion (matching ratio) of products for which this person actually stopped in front of the product shelf having the product, then it is possible to associate the customer ID corresponding to the person making the transaction with the transaction information. In particular, a threshold for the matching ratio is provided, and in a case where the matching ratio is greater than or equal to a predetermined value, then the customer ID is associated with the transaction information. On the other hand, in a case where the matching ratio is less than the predetermined value, the customer ID is not associated with the transaction information.

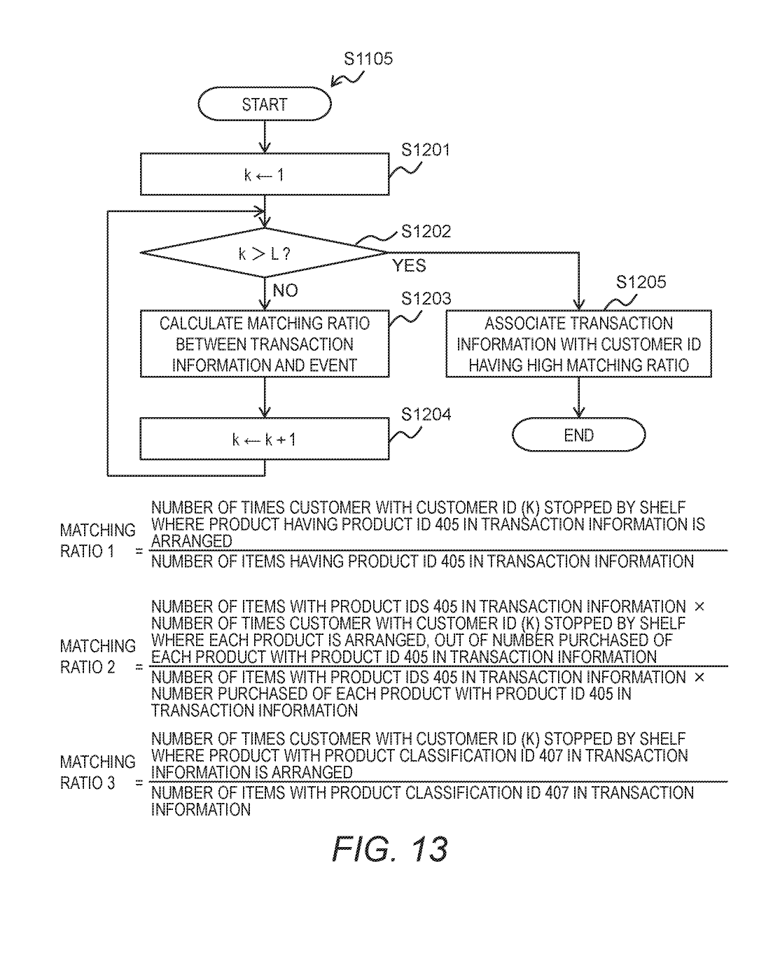

In Example 2, step S1105 of the motion line/transaction association information creation process (FIG. 12) of Example 1 is replaced with the flowchart illustrated in FIG. 13.

As a result of step S1103 in FIG. 12, an L number of customer IDs 301 were searched. The kth (1≦k≦L) customer ID 301 is expressed as customer ID (k).

First, the variable k is initialized to 1 (S1201). Next, it is determined whether the variable k is greater than L (S1202). In a case where the variable k is greater than L (S1202 returns “YES”), a customer ID 301 with the highest matching ratio among the matching ratios for the L customers calculated in step S1203 is selected, the customer ID 301 is associated with the transaction number 402, and the motion line/transaction association information 115 is created (S1205). Then, the process ends and returns to the motion line/transaction association information creation process (FIG. 12).

In step S1205, the customer ID 301 may be associated with the transaction number 402 by selecting the customer ID (k) with the matching ratio at a predetermined threshold, or selecting a predetermined number of customer IDs (k) in order from the highest matching ratio and additionally using another method starting with the selected customer IDs (k).

On the other hand, in a case where the variable k is less than or equal to L (S1202 returns “NO”), the matching ratio is calculated by the following method in order to determine whether a customer has stopped by an area 502, defining a path in front of a product section 503 where products with a product ID 405 in the transaction information are arranged, with reference to the shelving arrangement information 112 (S1203). The matching ratio is a value indicating the relationship between the product purchased by the customer and the shelf at which the customer stopped, and it can be determined that motion line information 108 and transaction information 109 having a high degree of relatedness regarding the product and the shelf are related to each other.

Specifically, the shelf at which the customer stopped is extracted from the event information 111, the product purchased by the customer is identified from the transaction information 109, products arranged on the shelf analyzed from the event information 111 are identified with reference to the shelving arrangement information 112, and the matching ratio between the products arranged on the shelf and the products identified from the transaction information is calculated.

For example, the matching ratio can be calculated by dividing the number of times the customer with the customer ID (k) stopped by the shelf at which the product with the product ID 405 of the transaction information is arranged, by the number of product IDs 405 of the transaction information (matching ratio 1 of FIG. 13).

Alternatively, the matching ratio may be calculated by determining a value by multiplying the number of times the customer with the customer ID (k) stopped by the shelf at which the product with the product ID 405 of the transaction information is arranged by the number of such products purchased, and dividing multiplied value by a number calculated by multiplying the number of product IDs 405 of the transaction information by the number of such products purchased (matching ratio 2 of FIG. 13).

Alternatively, the matching ratio may be calculated by dividing the number of times the customer with the customer ID (k) stopped by the shelf at which the product with the product classification ID 407 of the transaction information is arranged, by the number of product classification IDs 407 of the transaction information (matching ratio 3 of FIG. 13).

However, these are merely an example of calculation methods for the matching ratio, and the total quantity 409 may be used instead of the number of product IDs 405. Furthermore, the matching ratio may be defined according to the situation such as characteristics of the shop.

Next, the variable k is incremented by 1 (S1204), the process returns to step S1202, and the next customer ID is processed.

As described above, according to Example 2 of the present invention, the motion line association processing unit 105 analyzes the shelf at which the customer stops according to the event generated in the region in front of a pre-identified shelf from the event information 111, identifies the shelf at which the product purchased by the customer is arranged from the transaction information 109, calculates the matching ratio between the identification information for the shelf analyzed from the event information 111 and the identification information of the shelf identified from the transaction information 109, and associates the event with the highest matching ratio with the transaction information, and thus, even if the motion line information for some customers is absent, it is possible to appropriately associate the motion line information with the transaction information.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit, and may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, or an SD card.

The drawings illustrate control lines and information lines as considered necessary for explanation but do not illustrate all control lines or information lines in the products. It can be considered that almost of all components are actually interconnected.

What is claimed is:

1. A motion line processing system, which is formed by a computer including a processor and memory,
the motion line processing system being configured to access motion line information including a history of movement of a person measured by a position measurement device, event definition information including a condition for determining an occurrence of an event in a predetermined region, and transaction information including information of transaction of a product,
the motion line processing system comprising:
an event information creation unit configured to analyze the motion line information with reference to the event definition information, and create event information including a start time of the event, an end time of the event, and identification information of a person who has caused the event; and
an association processing unit configured to compare the event information with a transaction date and time included in the transaction information, and associate the motion line information with the transaction information in a case where the transaction date and time is included between the start time and the end time and the event is a transaction event at a transaction location.

2. The motion line processing system according to claim 1,
wherein the association processing unit is configured to associate an event with an earliest start time, among the events each having the transaction date and time between the start time and the end time, with the transaction information.

3. The motion line processing system according to claim 1,
wherein the motion line processing system is configured to access shelving arrangement information including a position where the product is arranged inside a shop, and
wherein the association processing unit is configured to:
analyze a shelf where a person has stopped according to an event generated in a region in front of a predetermined shelf, from the event information;
identify the product arranged on the analyzed shelf with reference to the shelving arrangement information;
identify a transacted product from the transaction information;
calculate a matching ratio between the product arranged on the shelf and the transacted product; and
associate an event with a highest matching ratio, among the transaction information having the transaction date and time between the start time and the end time, with the transaction information.

4. A motion line processing method executed by a computer including a processor and memory,
the computer being able to access motion line information including a history of movement of a person measured by a position measurement device, event definition information including a condition for determining an occurrence of an event in a predetermined region, and transaction information including information of transaction of a product, and
the method including:
an event information creation step of analyzing, by the processor, the motion line information with reference to the event definition information, creating event information including a start time of the event, an end time of the event and identification information of a person who has caused the event, and storing the event information in the memory; and
an association processing step of comparing, by the processor, the event information with a transaction date and time included in the transaction information, and storing in the memory information for associating the motion line information with the transaction information in a case where the transaction date and time is included between the start time and the end time and the event is a transaction event at a transaction location.

5. The motion line processing method according to claim 4,
wherein, in the association processing step, an event with an earliest start time, among the events each having the transaction date and time between the start time and the end time, is associated with the transaction information.

6. The motion line processing method according to claim 4,
wherein the computer can access shelving arrangement information including a position where the product is arranged inside a shop, and
wherein, in the association processing step,
a shelf where a person has stopped according to an event generated in a region in front of a predetermined shelf, from the event information is analyzed,
the product arranged on the analyzed shelf is identified with reference to the shelving arrangement information,
a transacted product is identified from the transaction information,
a matching ratio between the product arranged on the shelf and the transacted product is calculated, and
an event with a highest matching ratio, among the transaction information having the transaction date and time between the start time and the end time, is associated with the transaction information.
